(19) United States
(12) Patent Application Publication
(10) Pub. No.: US 2013/0174691 A1
(43) Pub. Date: Jul. 11, 2013

(54) Planetary arrangement of motors, masses around a axis of a flywheel

(71) Applicants: Carl William Astley, Lianddulas (GB); Dale Vernon Astley, Lianddulas (GB); Simon Mills, Old Colwyn (GB); Chris Rimell, Chester (GB); Kevin Nock, Towyn (GB); James Smith, Kinmel Bay (GB)

(72) Inventors: Carl William Astley, Lianddulas (GB); Dale Vernon Astley, Lianddulas (GB); Simon Mills, Old Colwyn (GB); Chris Rimell, Chester (GB); Kevin Nock, Towyn (GB); James Smith, Kinmel Bay (GB)

(21) Appl. No.: 13/714,126

(22) Filed: Dec. 13, 2012

Related U.S. Application Data
(60) Provisional application No. 61/576,469, filed on Dec. 16, 2011.

(51) Int. Cl. F16F 15/31

(52) U.S. Cl. CPC F16F 15/31
USPC 74/572.11

(57) ABSTRACT

A powered binary masses flywheel assembly device that will extract gravitational energy and store it together with the energy inputted externally into the flywheel in the form of rotational kinetic energy while rotating in the substantially vertically plane. The device can be used as part of a drive motor assembly to power machinery or as an electrical generator assembly. The binary masses arrangement in the flywheel enables the system to rotate at ever higher rpm using less power input per revolution the higher the rpm. This phenomenon starts to take place when the kinetic energy being stored in the rotating flywheel disc is exceeded by the kinetic energy stored in the binary masses attached to the flywheel disc which form the flywheel assembly.

### CROSS-REFERENCE TO RELATED APPLICATIONS

This application benefit Claims To Prior Applications under 35 U.S.C. §§119(e) Application No. 61/576,469 filing date Dec. 16, 2011

### PATENT HISTORY

Flywheels are used for power smoothing and power storage. The basic design and function of flywheels has remained unchanged since the Neolithic times.

### FIELD OF INVENTION

A flywheel is heavy revolving wheel in a machine that is used to increase the machine's momentum and thereby provide greater stability or a reserve of available power during interruptions in the delivery of power to the machine.

### BACKGROUND OF THE CONVENTIONAL ART

Flywheels have been designed and used with the presumed knowledge that you can only recover the energy you have inputted into flywheel and stored in the form of rotational kinetic energy less any dissipative forces acting on the flywheel system. Advancement in the design of flywheels has been mainly in the area of greater rotational speed or revolutions per minute (rpm) and reducing dissipative forces, in order to store more usable energy. However, as flywheel rpm increases the internal loading on the flywheel structure increases dramatically, requiring the need for ever more sophisticated lightweight high tensile strength materials such that carbon fibre composites possess. In order to safely withstand the very large centripetal loading which occur when rotating at these high rpm in relation to the total mass of the flywheel, when a flywheel is rotated at high speeds, any minor flaws in the construction of the flywheel can cause catastrophic failure to occur.

### SUMMARY OF THE DEVICE

An assembly of a powered flywheel with binary planetary masses device will store the rotational kinetic energy that is inputted into the flywheel assembly less any dissipative forces and will also gather additional rotational kinetic energy from rotating substantially in the vertical position in a gravitational field. A proportion of this rotational kinetic energy, derived from the inputted and gravitational force can now be recovered as useable energy at low speeds or high speed dependent on the diameter of the flywheel and masses applied to the flywheel. The greater the diameter and larger the masses the more useable energy can be recovered at ever lower rpm. The amount of usable energy recovered from the device will exceed the energy inputted into the device assembly by the coupled motor when rotating above a critical rpm determined by the a relationship between the flywheel disc, the masses and the radius of the masses from the centre of the rotational axis.

### DRAWINGS

Introduction to drawings:

FIG. 1. Flywheel:

A assembly of a flywheel coupled to a roatable shaft supported by bearings.

FIG. 2. Flywheel, motor and generator:

A assembly of a powered flywheel coupled to a roatable shaft supported by bearings and coupled to an input motor and output generator

FIG. 3. Flywheel assembly

A powered flywheel assemble as in FIG. 2. With additional masses in a binary grouping configuration.

FIG. 4. Graphical representations of motor input, generator output power verses rpm

FIG. 5. Device preferred embodiment

### DETAILED DESCRIPTION OF THE DEVICE

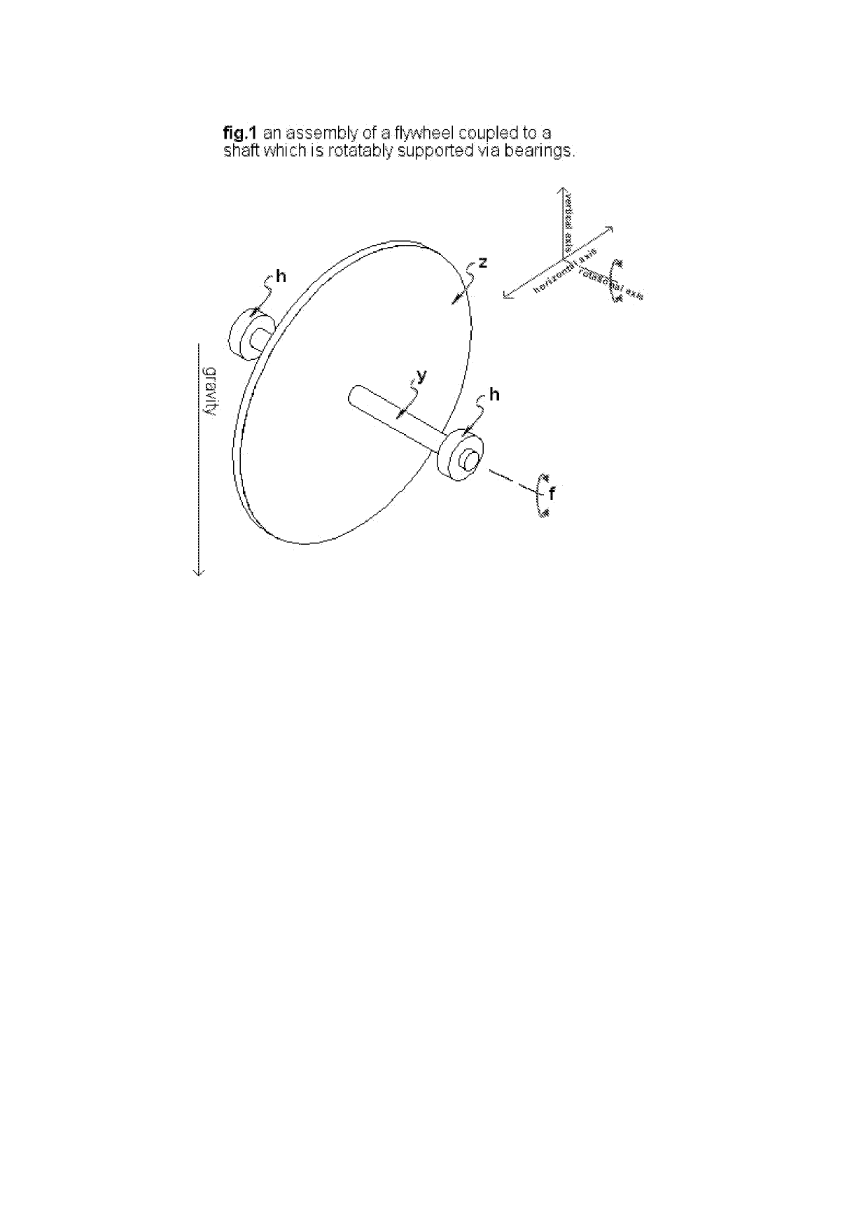

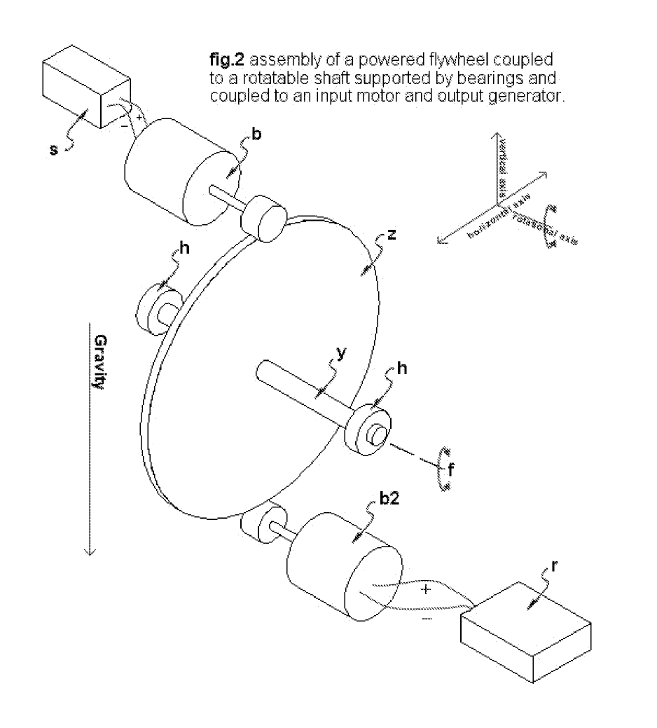

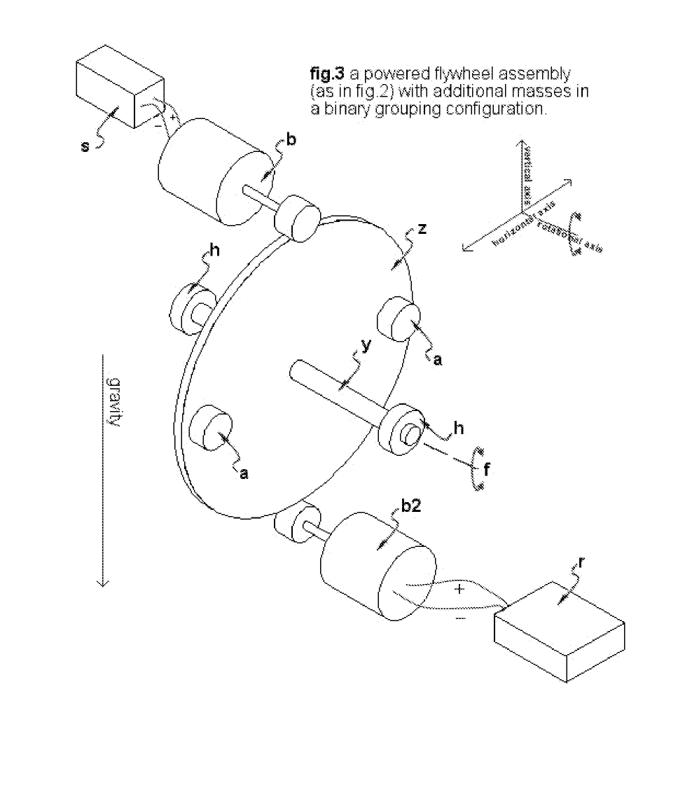

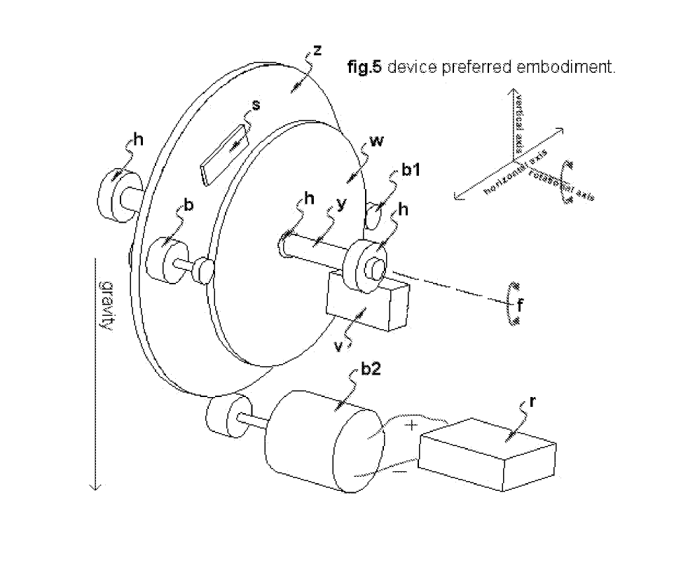

A powered flywheel assembly mounted in the substantial vertical position FIG. 2 with masses FIG. 3(a) attached to the flywheel disc FIG. 1(z) coupled to a roatable shaft FIG. 1(y) supported by bearings FIG. 1(h). The masses FIG. 3(a) should be positioned in such a position as to give the flywheel assembly FIG. 3 horizontal balance through the centre of gravity of the masses FIG. 3(a) about the rotational axis FIG. 3(f). The flywheel devise FIG. 3 is designed to be rotated about its axis FIG. 3(f), as it is rotated it gathers and stores the energy inputted by the coupled motor FIG. 3(b) and recovered gravitational energy in the form of rotational kinetic energy less any dissipative forces. An appropriate proportion of energy relative to the devices flywheel disk FIG. 1(z) diameter, total masses FIG. 3(a) of the device and its rpm in the form of rotational kinetic energy stored in the flywheel assembly FIG. 3 can be recovered through the generator FIG. 3(b2). Generator FIG. 5(b2) can alternatively be coupled to the shaft FIG. 1(y). In the preferred device the motor FIG. 5(b) is coupled to a drive plate FIG. 5(w) the drive plate FIG. 5(w) is independently rotatable about the rotational axis FIG. 5(f) of shaft FIG. 5(y) supported by bearings FIG. 5(h). When drive plate FIG. 5(w) is not allowed to rotate by the friction brake FIG. 5(v), the coupled motor FIG. 5(b) will impart rotation onto the flywheel FIG. 5(z). The flywheel disc FIG. 1(z) will have a moment of Inertia about its rotational axis FIG. 1(f), also the masses FIG. 3(a) attached to the flywheel disk FIG. 1(z) will have moments of inertia about the flywheel assembly FIG. 3 rotational axis FIG. 3(f). When the flywheel assemble is rotated, the moment of Inertia of the flywheel and the attached masses can be calculated individually and summated using rotational Inertial equations based on mass and angular velocity or rpm of the flywheel assembly FIG. 3 as it is rotating. Significantly, at lower rpm the kinetic energy in the rotating disc FIG. 1(z) will exceed the kinetic energy in the attached masses FIG. 3(a). As the rotational speed/rpm is increased, the kinetic energy in the attached masses will increase at a rate faster than the rise in kinetic energy of the flywheel disc.

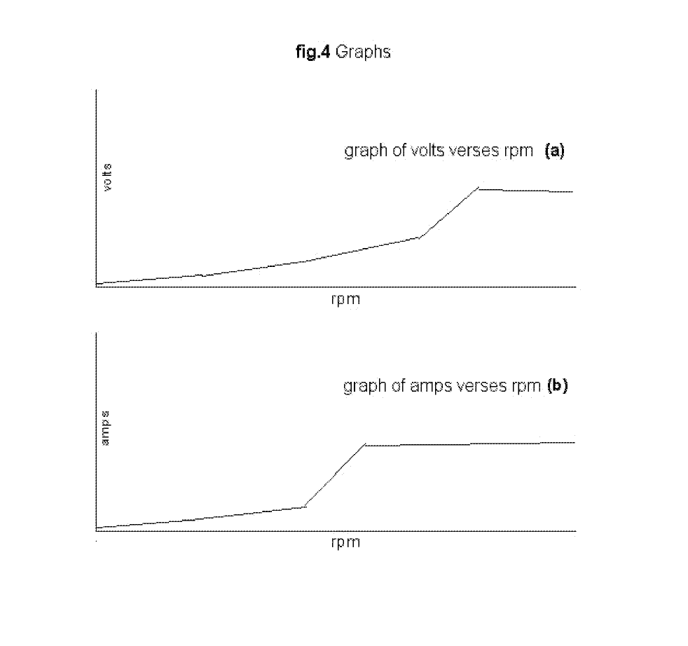

At the point where the Kinetic energy in the attached masses FIG. 3(a) exceeds the kinetic energy in the flywheel disc FIG. 1(z) the flywheel assembly FIG. 3 will begin to accelerate for the same continued energy input from the motor FIG. 3(b), as shown in the graph FIG. 4(1&2). This device when rotating above the kinetic energy balance point between the flywheel disc FIG. 1(z) and masses FIG. 3(a) enables useable energy to be outputted by the flywheel assembly FIG. 3 through the coupled generator FIG. 3(b2) which is coupled to a resistive load FIG. 3(r). The motor FIG. 3(b) is controlled by a microprocessor control unit FIG. 3(s). When rotational speed rpm exceeds the minimum for kinetic energy balance between flywheel disc FIG. 1(z) and masses FIG. 3(a), at a calculable angular velocity using rotational inertia equations the useful rotational kinetic energy that can be extracted from the flywheel device by a electrical generating device coupled to the said flywheel assembly FIG. 3 shaft FIG. 3(y) or coupled to the perimeter of the said flywheel disc FIG. 1(z) will exceed the power inputted into the said flywheel assembly FIG. 3 through the said motor FIG. 3(b) input coupling at the rotational axis FIG. 3(f) or perimeter of the said flywheel disc FIG. 1(z). At this angular velocity the said flywheel assemble FIG. 3 output generator FIG. 3(b2) will produce more power than is being consumed by the said input motor FIG. 3(b) maintaining its angular velocity by extracting the additional energy it has produced from the gravitational field it is within. Graphical representation of this effect, is shown in FIG. 4 detailing graphical the voltage FIG. 4(a) verses rpm represented by the line between axis. FIG. 4(b) shows Amps verses rpm represented by the line between axis. From these types of graphs FIG. 4(a,b) power (watts) consumed by the motor FIG. 3(b) and resistance of the motor FIG. 3(b) can be calculated. The said planetary arrangement of masses within a powered flywheel is not constrained by physical size. The said device can be manufactured in scales ranging from the atomic level to planetary size, since all matter in the Universe rotates about an axis when temperatures exceed zero degrees Kelvin. The said planetary arrangement of masses within a powered flywheel is not limited to what is described, but also includes undescribed equivalents of the device that is recited in the claims.

### Preferred Embodiments

The said flywheel assembly FIG. 5. In accordance with a preferred embodiment of the present invention shows a flywheel assembly FIG. 1 with attached masses that are also motors FIG. 5(a) and generators FIG. 5(b1) in a binary grouping and a generator FIG. 5(b2) coupled to the perimeter of the flywheel FIG. 5(z) The motors drive the perimeter of the flywheel through a coupling to a drive plate FIG. 5(w). The motors FIG. 5(b) power the flywheel FIG. 5(z) rotabley moving about the rotation axis FIG. 5(f) by exerting a force on the fixed or variable speed drive plate FIG. 5(w) supported by bearings FIG. 5(h), the variable speed drive plate rotation is controlled by a friction brake FIG. 5(v). The output from generator FIG. 5(b1) powers the motor FIG. 5(a) through a control unit FIG. 5(k) incorporating remote sensors and the generator FIG. 5(b2) will provide useable power to the resistive load.

We claim:

1. A flywheel assembly: consisting of a flywheel with a moment of inertia equal to ½*Mass*Radius squared; and masses arranged in a binary grouping, and coupled to a shaft which is rotatably mounted via bearings.

2. An assembly of claim 1; which comprises of the centre of gravity of each element of the said binary grouping of the said masses; and positioned on the same or parallel plane at 180 degrees apart, and about the central rotational axis of the said flywheel assembly;

3. An assembly of claim 1; which comprises of each of the said binary element of the said binary group masses positioned along the said flywheels diameter at a radius of the said flywheel; and that will give a horizontal balance of the said binary grouped masses on the said flywheel.

4. An assembly of claim 1; consisting of the said masses incorporated into the said flywheel; and substantially located towards the perimeter of the said flywheel assembly.

5. An assembly of claim 1; which comprises the said flywheel assembly; and is mounted substantially in the vertical position.

6. An assembly of claim 1; wherein the said flywheel assembly is rotated about its centre axis from its perimeter.

7. An assembly of claim 1; wherein the said masses can be comprised of motors; and generators; and rotated about its centre axis from its perimeter by the said motors.

8. An assembly of claim 1; wherein the said flywheel assembly is rotated about its centre axis.

9. An assembly of claim 1; wherein the said flywheel assembly coupled to the said shaft mounted on the said bearings; and comprises a couple to a generator; and rotates on the axis of the said flywheel assembly.

10. An assembly of claim 1; which comprises the said flywheel assembly; and a generator coupled to the perimeter of the said flywheel assembly; and rotate the generator about its own rotational axis.

11. An assembly of claim 1; wherein the said masses be comprised of motors; and can be electrical, mechanical, pneumatic, hydraulic or organic motors.

12. An assembly of claim 1; wherein the said masses be comprised of generators; and can be electrical, mechanical, pneumatic, hydraulic or organic generators.
